(19) United States
(12) Patent Application Publication
(10) Pub. No.: US 2021/0082405 A1
(43) Pub. Date: Mar. 18, 2021

(54) Method for Location Reminder and Electronic Device

(71) Applicant: GUANGDONG OPPO MOBILE TELECOMMUNICATIONS CORP., LTD., Dongguan, (CN)

(72) Inventors: Jiafei Liu, Dongguan (CN); Jian Da, Dongguan (CN); Wanjiang Xiong, Dongguan (CN); Haiquan Li, Dongguan (CN); Wurun Zhou, Dongguan (CN); Zhi Dong, Dongguan (CN); Zhonglei Zhu, Dongguan (CN); Zhaoyan Wen, Dongguan (CN); Liang Gao, Dongguan (CN); Guan Li, Dongguan (CN)

(21) Appl. No.: 17/107,011

(22) Filed: Nov. 30, 2020

Related U.S. Application Data
(63) Continuation of application No. PCT/CN2019/086381, filed on May 10, 2019.

(30) Foreign Application Priority Data
May 30, 2018 (CN) 201810540827.X

(51) Int. Cl. G10L 15/10; G10L 15/22; H04W 4/02

(52) U.S. Cl. CPC G10L 15/10; H04W 4/02; G10L 15/22

(57) ABSTRACT

A method for location reminder and an electronic device are disclosed. The method includes extracting a target voiceprint feature from a voice configured for searching for a terminal; determining whether the target voiceprint feature meets a preset condition in relation to a preset voiceprint feature, in response to the target voiceprint feature unmatching with the preset voiceprint feature; detecting whether the terminal is located at a preset location in response to the target voiceprint feature meeting the preset condition in relation to the preset voiceprint feature; and triggering a location reminder in a preset manner for reminding a user where the terminal is, in response to the terminal being located at the preset location.

### CROSS-REFERENCE TO RELATED APPLICATIONS

This application is a continuation-application of International (PCT) Patent Application No. PCT/CN2019/086381 filed on May 10, 2019, which claims priority to Chinese Patent Application No. 201810540827.X, filed on May 30, 2018, the entire contents of both of which are herein incorporated by reference.

### TECHNICAL FIELD

The present disclosure generally relates to the technical field of terminals, and in particular to a method for location reminder, a non-transitory storage medium, and an electronic device.

### BACKGROUND

With the development of technology, the interaction between humans and machines has become more and more abundant. Users can control a terminal through voice. That is, after receiving voice information sent by the user, the terminal can parse the voice information to obtain a control instruction. Before executing the control instruction, the terminal needs to extract voiceprint features from the voice information, and perform voiceprint recognition according to the extracted voiceprint features. Only after the voiceprint recognition is passed, the terminal will execute the control instruction corresponding to the voice information.

### SUMMARY

According to one aspect of the present disclosure, a method for location reminder is provided, which includes extracting a target voiceprint feature from a voice configured for searching for a terminal; determining whether the target voiceprint feature meets a preset condition in relation to a preset voiceprint feature, in response to the target voiceprint feature unmatching with the preset voiceprint feature; detecting whether the terminal is located at a preset location in response to the target voiceprint feature meeting the preset condition in relation to the preset voiceprint feature; and triggering a location reminder in a preset manner for reminding a user where the terminal is, in response to the terminal being located at the preset location.

According to another aspect of the present disclosure, an electronic device is provided, which includes a memory and a processor, wherein the processor is configured for executing a computer program stored in the memory to perform: extracting a target voiceprint feature from a voice configured for searching for a terminal; determining whether the target voiceprint feature meets a preset condition in relation to a preset voiceprint feature, in response to the target voiceprint feature unmatching with the preset voiceprint feature; detecting whether the terminal is located at a preset location in response to the target voiceprint feature meeting the preset condition in relation to the preset voiceprint feature; and triggering a location reminder in a preset manner for reminding a user where the terminal is, in response to the terminal being located at the preset location.

According to yet another aspect of the present disclosure, A non-transitory storage medium storing a computer program, when executed on a computer, causing the computer to perform: determining whether a target voiceprint feature meets a preset condition in relation to a preset voiceprint feature, in response to the target voiceprint feature unmatching with the preset voiceprint feature, the target voiceprint feature being extracted from a voice configured for searching for a terminal; detecting whether the terminal is located at a preset location in response to the target voiceprint feature meeting the preset condition in relation to the preset voiceprint feature; and triggering a location reminder in a preset manner for reminding a user where the terminal is, in response to the terminal being located at the preset location.

### BRIEF DESCRIPTION OF THE DRAWINGS

Detailed embodiments of the present disclosure are described in detail with the accompanying drawings to make technical solutions and other advantageous effects of the present disclosure more obvious.

FIG. 1 is a flow chart of a method for location reminder according to some embodiments of the present disclosure;

FIG. 2 is another flow chart of a method for location reminder according to some embodiments of the present disclosure;

FIGS. 3-5 are schematic diagrams of scenarios for a method for location reminder according to some embodiments of the present disclosure.

FIG. 6 is a structural view of an apparatus for location reminder according to some embodiments of the present disclosure;

FIG. 7 is another structural view of an apparatus for location reminder according to some embodiments of the present disclosure;

FIG. 8 is a structural view of a mobile terminal according to an embodiment of the present disclosure; and

FIG. 9 is another structural view of a mobile terminal according to an embodiment of the present disclosure.

### DETAILED DESCRIPTION

Referring to the drawings, in which like reference numerals represent same components, the principles of the present disclosure are illustrated by the implementation in a suitable computing environment. The following description is based on specific embodiments of the present disclosure as illustrated, and should not be construed as limiting other specific embodiments that are not described herein.

Embodiments of the present disclosure provide a method for location reminder, which includes: extracting a target voiceprint feature from a voice configured for searching for a terminal; determining whether the target voiceprint feature meets a preset condition in relation to a preset voiceprint feature, in response to the target voiceprint feature unmatching with the preset voiceprint feature; detecting whether the terminal is located at a preset location in response to the target voiceprint feature meeting the preset condition in relation to the preset voiceprint feature; and triggering a location reminder in a preset manner for reminding a user where the terminal is, in response to the terminal being located at the preset location.

In some embodiments, before the triggering a location reminder in a preset manner for reminding a user where the terminal is, the method further includes: obtaining a noise value of a current environment in which the terminal is located; and determining a target volume value according to the noise value.

The triggering a location reminder in a preset manner for reminding a user where the terminal is comprises triggering the location reminder by a ringtone with the target volume value for reminding the user where the terminal is.

In some embodiments, after the triggering the location reminder by a ringtone with the target volume value, the method further includes: increasing the target volume value of the ringtone, in response to the terminal not being found by the user after a preset duration; and continuously triggering the location reminder by the ringtone with the increased target volume value for reminding the user where the terminal is.

In some embodiments, before the triggering a location reminder in a preset manner for reminding a user where the terminal is, the method further includes: obtaining a noise value of a current environment in which the terminal is located; and obtaining a volume value of the voice, in response to the noise value is less than a preset threshold.

The triggering a location reminder in a preset manner for reminding a user where the terminal is comprises: triggering the location reminder by a ringtone with the volume value for reminding the user where the terminal is.

In some embodiments, the determining whether the target voiceprint feature meets a preset condition in relation to a preset voiceprint feature comprises: obtaining a target matching degree between the target voiceprint feature and the preset voiceprint feature; obtaining a difference between the target matching degree and a preset matching threshold; determining the target voiceprint feature meets the preset condition in relation to the preset voiceprint feature, in response to the difference being less than or equal to a preset difference; and determining the target voiceprint feature does not meet the preset condition in relation to the preset voiceprint feature, in response to the difference being greater than the preset difference.

In some embodiments, the larger the noise value, the larger the target volume value is.

In some embodiments, the determining whether the terminal is located at a preset location comprises: obtaining information of a WiFi access point to which the terminal is currently connected; and determining whether the information of the WiFi access point is information of a preset WiFi access point, wherein the information of the preset WiFi access point being information of any of at least one WiFi access point at the preset location; and determining that the terminal is located at the preset location, in response the information of the WiFi access point being the information of the preset WiFi access point.

Embodiments of the present disclosure provide an electronic device, including a memory and a processor, wherein the processor is configured for executing a computer program stored in the memory to perform: extracting a target voiceprint feature from a voice configured for searching for a terminal; determining whether the target voiceprint feature meets a preset condition in relation to a preset voiceprint feature, in response to the target voiceprint feature unmatching with the preset voiceprint feature; detecting whether the terminal is located at a preset location in response to the target voiceprint feature meeting the preset condition in relation to the preset voiceprint feature; and triggering a location reminder in a preset manner for reminding a user where the terminal is, in response to the terminal being located at the preset location.

In some embodiments, the processor is configured for: obtaining a noise value of a current environment in which the terminal is located; determining a target volume value according to the noise value; and triggering the location reminder by a ringtone with the target volume value for reminding the user where the terminal is.

In some embodiments, the processor is configured for: increasing the target volume value of the ringtone, in response to the terminal not being found by the user after a preset duration; and continuously triggering the location reminder by the ringtone with the increased target volume value for reminding the user where the terminal is.

In some embodiments, the processor is configured for: obtaining a noise value of a current environment in which the terminal is located; obtaining a volume value of the voice in response to the noise value is less than a preset threshold; and triggering the location reminder by a ringtone with the volume value for reminding the user where the terminal is.

In some embodiments, the processor is configured for: obtaining a target matching degree between the target voiceprint feature and the preset voiceprint feature; obtaining a difference between the target matching degree and a preset matching threshold; determining the target voiceprint feature meets the preset condition in relation to the preset voiceprint feature, in response to the difference being less than or equal to a preset difference; and determining the target voiceprint feature does not meet the preset condition in relation to the preset voiceprint feature, in response to the difference being greater than the preset difference.

In some embodiments, the larger the noise value is, the larger the target volume value is.

In some embodiments, the processor is configured for: obtaining information of a WiFi access point to which the electronic device is currently connected; and determining whether the information of the WiFi access point is information of a preset WiFi access point, wherein the information of the preset WiFi access point being information of any of at least one WiFi access point at the preset location; and determining that the electronic device is located at the preset location in response the information of the WiFi access point being the preset information of the WiFi access point.

Embodiments of the present disclosure provide a non-transitory storage medium storing a computer program, when executed on a computer, causing the computer to perform: determining whether a target voiceprint feature meets a preset condition in relation to a preset voiceprint feature, in response to the target voiceprint feature unmatching with the preset voiceprint feature, the target voiceprint feature being extracted from a voice configured for searching for a terminal; detecting whether the terminal is located at a preset location in response to the target voiceprint feature meeting the preset condition in relation to the preset voiceprint feature; and triggering a location reminder in a preset manner for reminding a user where the terminal is, in response to the terminal being located at the preset location.

In some embodiments, the computer program causing the computer to further perform: obtaining a noise value of a current environment in which the terminal is located; determining a target volume value according to the noise value; and triggering the location reminder by a ringtone with the target volume value for reminding the user where the terminal is.

In some embodiments, the computer program causing the computer to further perform: increasing the target volume value of the ringtone, in response to the terminal not being found by the user after a preset duration; and continuously triggering the location reminder by the ringtone with the increased target volume value for reminding the user where the terminal is.

In some embodiments, the larger the noise value is, the larger the target volume value is.

In some embodiments, the computer program causing the computer to further perform: obtaining a target matching degree between the target voiceprint feature and the preset voiceprint feature; obtaining a difference between the target matching degree and a preset matching threshold; determining the target voiceprint feature meets the preset condition in relation to the preset voiceprint feature, in response to the difference being less than or equal to a preset difference; and determining the target voiceprint feature does not meet the preset condition in relation to the preset voiceprint feature, in response to the difference being greater than the preset difference.

In some embodiments, the computer program causing the computer to further perform: obtaining information of a WiFi access point to which the terminal is currently connected; and determining whether the information of the WiFi access point is information of a preset WiFi access point, wherein the information of the preset WiFi access point being information of any of at least one WiFi access point at the preset location; and determining that the terminal is located at the preset location, in response the information of the WiFi access point being the information of the preset WiFi access point.

It can be understood that the execution subject of embodiments of the present disclosure may be a terminal device such as a smart phone or a tablet computer.

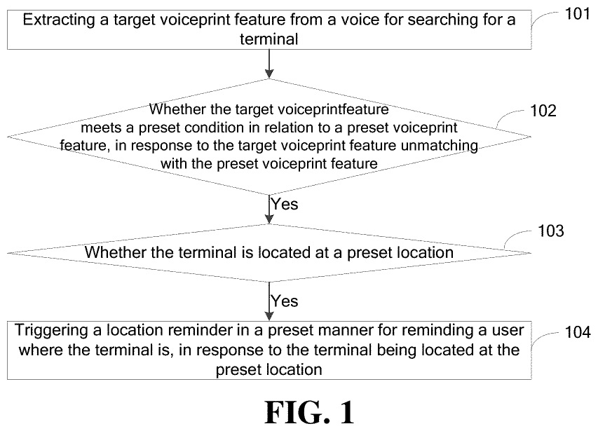

FIG. 1 is a schematic flowchart of a method for location reminder according to some embodiments of the present disclosure. The method may include actions/operations in the following.

At 101, the method extracts a target voiceprint feature from a voice for searching for a terminal.

With the development of technology, the interaction between humans and machines has become more and more abundant. Users can control a terminal through voice. That is, after receiving voice information sent by the user, a terminal can parse the voice information to obtain a control instruction. Before executing the control instruction, the terminal needs to extract voiceprint features from the voice information, and perform voiceprint recognition according to the extracted voiceprint features. Only after the voiceprint recognition is passed, the terminal will execute the control instruction corresponding to the voice information. However, the terminal has poor flexibility in implementing voice control.

In 101 of embodiments of the present disclosure, for example, after receiving the voice for searching for the terminal from a user, the terminal may extract voiceprint feature of the user from the voice, which is the target voiceprint feature.

In some embodiments, a mobile phone is used as an example. For example, a user pre-recorded a target voice of “where are you, Xiaoou”, and the target voice is used to search for the mobile phone. An operation corresponding to the target voice is to trigger the mobile phone to light its screen and output a ringtone to remind the user where the mobile phone is currently located, and thus it is easy for the user to find the mobile phone. For example, a function realized by the target voice may be referred to as function of searching mobile phones. In other words, when the user speaks out the voice of “Where are you? Xiaoou”, the mobile phone will light its screen and output a ringtone simultaneously, so that the user can find the mobile phone as soon as possible according to the ringtone emitted by the mobile phone and the lighted screen.

After the target voice is set, when the user utters a certain voice, for example, when the user utters a voice such as “Where are you? Xiaoou”, “Xiaoou, where are you?”, or “where are you now? Xiaoou”, the mobile phone analyzes these voices, and can determine that these voices are used by the user to search for the mobile phone. At this time, the mobile phone can extract a target voiceprint feature of the user from the received voice.

After extracting the target voiceprint feature of the user, the terminal may detect whether the target voiceprint feature matches with a preset voiceprint feature. In some embodiments, the preset voiceprint feature may be a voiceprint feature of an owner of the terminal, or a voiceprint feature of a user (such as the owner's family) who can use the terminal after permission of the owner.

If the target voiceprint feature matches with the preset voiceprint feature, the terminal may perform a corresponding operation.

If the target voiceprint feature does not match with the preset voiceprint feature, then action/operation at 102 is performed.

At 102, the method determines whether the target voiceprint feature meets a preset condition in relation to a preset voiceprint feature, in response to the target voiceprint feature unmatching with the preset voiceprint feature.

For example, if the terminal detects that the target voiceprint feature of the user does not match the preset voiceprint feature, then the terminal may determine whether the target voiceprint feature meets a preset condition in relation to the preset voiceprint feature.

If the target voiceprint feature does not meet the preset condition in relation to the preset voiceprint feature, the terminal may perform other operations.

If the target voiceprint feature meets the preset condition in relation to the preset voiceprint feature, then action/operation at 103 is performed.

At 103, the method detects whether the terminal is located at a preset location, in response to the target voiceprint feature meeting the preset condition in relation to the preset voiceprint feature.

For example, if the terminal detects that the target voiceprint feature of the user does not match with the preset voiceprint feature, but the target voiceprint feature meeting the preset condition in relation to the preset voiceprint feature, the terminal can determine whether the terminal is located at the preset location. For example, the preset location may be a user's home or company.

If it is determined that the terminal is not at the preset location, the terminal may perform other operations. If it is determined that the terminal is located at the preset location, then action/operation at 104 is performed.

At 104, the method triggers a location reminder in a preset manner for reminding a user where the terminal is, in response to the terminal being located at the preset location.

For example, the terminal determines that it is located at a preset location. In this case, the terminal may trigger a location reminder in the preset manner for reminding the user where the terminal is. For example, the terminal may output a ringtone and light its screen simultaneously to remind the user where the terminal is currently located, so that the user can easily find the terminal.

It can be understood that, in this embodiment, after receiving a voice for searching for the terminal, the terminal may detect whether the terminal is located at a preset location when a voiceprint feature included in the voice does not match with the preset voiceprint feature but the preset condition is met between both voiceprint feature. The terminal may remind the user where the terminal is in a preset manner in response to the terminal being located at a preset location. Therefore, compared to a case in which the terminal performs a corresponding operation only when the user's voiceprint feature matches with the preset voiceprint feature, this improves flexibility of the terminal when implementing voice control, because the terminal performs a corresponding operation when the user's voiceprint feature matches with the preset voiceprint feature and a certain condition is met in this embodiment.

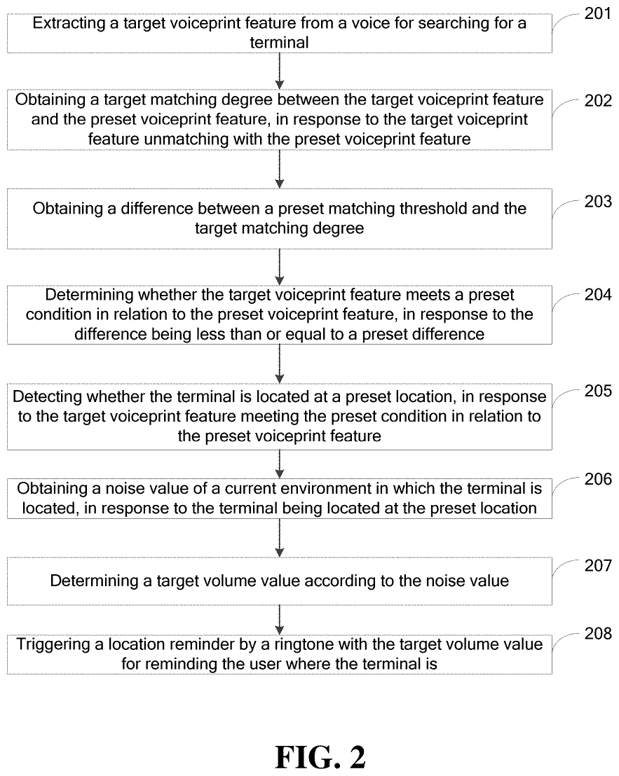

FIG. 2 is another schematic flowchart of a method for location reminder according to some embodiments of the present disclosure. The method may include actions/operations in the following.

At 201, the method extracts a target voiceprint feature from a voice for searching for a terminal.

For example, a user pre-records a target voice of “where are you, Xiaoou”, and the target voice is used to search for a mobile phone. An operation corresponding to the target voice is to trigger the mobile phone to light its screen and output a ringtone to remind the user where the mobile phone is currently located, and thus it is easy for the user to find the phone.

After receiving the voice of “Where are you? Xiaoou” from the user, the terminal may first extract the voiceprint feature of the user from the voice, which is the target voiceprint feature.

After extracting the target voiceprint feature of the user, the terminal may compare the target voiceprint feature with a preset voiceprint feature and then determine whether the target voiceprint feature matches with the preset voiceprint feature. In some embodiments, the preset voiceprint feature may be a voiceprint feature of an owner of the terminal, or a voiceprint feature of a user (such as the owner's family) who can use the terminal after permission of the owner.

For example, when comparing the target voiceprint feature with the preset voiceprint feature, the terminal can calculate a matching degree between the target voice feature and the preset voiceprint feature, and then the terminal can determine whether the matching degree reaches a preset matching threshold. If the matching degree reaches the preset matching threshold, it can be determined that the target voiceprint feature matches with the preset voiceprint feature. If the matching degree does not reach the preset matching threshold, it can be determined that the target voiceprint feature does not match with the preset voiceprint feature.

If it is detected that the target voiceprint feature matches with the preset voiceprint feature, then the terminal may perform an operation corresponding to the matching.

If it is detected that the target voiceprint feature does not match with the preset voiceprint feature, then an action/operation at 202 is performed.

At 202, the method obtains a target matching degree between the target voiceprint feature and the preset voiceprint feature, in response to the target voiceprint feature unmatching with the preset voiceprint feature.

At 203, the method obtains a difference between a preset matching threshold and the target matching degree.

At 204, the method determines whether the target voiceprint feature meets a preset condition in relation to the preset voiceprint feature, in response to the difference being less than or equal to a preset difference.

For example, actions/operations at 202, 203, and 204 may include the following.

The terminal detects that the target voiceprint feature of the user does not match with the preset voiceprint feature, and then the terminal may obtain the matching degree between the target voiceprint feature and the preset voiceprint feature, which is the target matching degree.

After acquiring the target matching degree, the terminal may acquire the difference between the target matching degree and a preset matching threshold.

For example, since the target voiceprint feature of the user does not match with the preset voiceprint feature, it can be determined that the target matching degree between the target voiceprint feature and the preset voiceprint feature is less than the preset matching threshold. In this case, the terminal may acquire the difference between the target matching degree and the preset matching threshold. For example, if the target matching degree between the user's target voiceprint feature and the preset voiceprint feature is 86%, and the preset matching threshold is 90%, then the difference between the target matching degree and the preset matching threshold is 4%.

After acquiring the difference between the target matching degree and the preset matching threshold, the terminal may detect whether the difference is less than or equal to a preset difference. For example, the preset difference may be 5%. Of course, the preset difference can also be other values, such as 6% or 8%, etc.

If it is detected that the difference between the target matching degree and the preset matching threshold is greater than the preset difference, for example, the target matching degree is 80%, the preset matching threshold is 90%, and the difference between the target matching degree and the preset matching threshold is 10% and greater than the preset matching threshold 5%, the voiceprint feature of the current user may be considered to be too different from the preset voiceprint feature, and the current user may be considered an illegal user. At this time, the terminal may refuse to perform a corresponding operation. For example, the terminal may not light its screen and output a ringtone. In addition, the terminal can also perform other operations for security protection to prevent the terminal from being illegally operated by the illegal user. For example, if it is detected that the current user is an illegal user, the terminal may start a camera to obtain a face image of the current user, and then upload the face image to a cloud server preset by the owner so that the owner can trace the illegal user. Alternatively, the terminal may hide icons of important applications, so that illegal users cannot operate these important applications.

If the difference between the target matching degree and the preset matching threshold is detected to be less than or equal to the preset difference, for example, the target matching degree is 86%, the preset matching threshold is 90%, and the difference is 4% and less than the preset matching threshold 5%, it can be considered that the target voiceprint feature of the current user is close to the preset voiceprint feature. In other words, the current user is likely to be a legal user, but due to a slight change in the voiceprint of the current user, it results in the low matching degree between the current user's target voiceprint feature and the preset voiceprint feature.

It should be noted that, a voiceprint feature is mainly determined by two factors. One of the two factors is a size of the sound cavity, including the throat, nasal cavity and oral cavity. A size of the vocal cord tension and a frequency range of sounds is determined by shapes, sizes and locations of these organs. The other of the two factors determining the voiceprint feature is a way in which vocal organs are manipulated. The vocal organs include lips, teeth, tongue, soft palate, and palate muscles, which works together to produce a clear voice. In other words, the voiceprint is closely related to the physiological characteristics of the human body. In daily life, for example, throat inflammation when the user gets cold will cause the user's voice to become hoarse, or the user's voiceprint will also change slightly when the user speaks while eating food. In these cases, since the user's voiceprint has changed, a matching degree between the user's voiceprint feature and a preset voiceprint feature may be slightly less than the preset matching threshold.

When detecting that the difference between the target matching degree (between the user's target voiceprint feature and the preset voiceprint feature) and the preset matching threshold is less than or equal to a preset difference, the terminal may determine that the target voiceprint feature meets the preset condition in relation to the preset voiceprint feature.

At 205, the method detects whether the terminal is located at a preset location, in response to the target voiceprint feature meeting the preset condition in relation to the preset voiceprint feature.

For example, when it is determined that the target voiceprint feature meets the preset condition in relation to the preset voiceprint feature, the terminal may detect whether the terminal is located at a preset location. In some embodiments, the preset location may be a commonly used location such as the user's home or company.

If it is detected that the terminal is not located at the preset location, the terminal can perform other operations.

If it is detected that the terminal is located at the preset location, then perform an action/operation at 206.

At 206, the method obtains a noise value of a current environment in which the terminal is located, in response to the terminal being located at the preset location.

At 207, the method determines a target volume value according to the noise value.

At 208, the method triggers a location reminder by a ringtone with the target volume value for reminding the user where the terminal is.

For example, actions/operations at 206, 207, and 208 may include the following.

The terminal detects that the terminal is located at a preset location, which means that the target voiceprint feature of the user closely matches with the preset voiceprint feature and the terminal is located at a preset location such as the user's home or company, the current user may be considered as an legal user. At this time, the terminal can remind the user where the terminal is in a preset manner so that the user can find the terminal.

For example, in this embodiment, when the terminal triggers a location reminder in a preset manner for reminding the user where the terminal is, it may first obtain the noise value of the current environment, and then determine a target volume value according to the noise value. Then the terminal triggers a location reminder by a ringtone with the target volume value for reminding the user where the terminal is, so that the user can find the terminal.

In some embodiments, the larger the noise value is, the larger the target volume value is.

In some embodiments, after triggering a location reminder by a ringtone with the target volume value for reminding the user where the terminal is, the method further includes the following.

The method increases the target volume value of the ringtone, in response to the terminal being not found by the user after a preset duration.

And the method continuously triggers the location reminder by the ringtone with the increased target volume value for reminding the user where the terminal is.

For example, after triggering a location reminder by a ringtone with the target volume value for reminding the user where the terminal is, if the terminal detects that the user has not yet found the terminal after a preset time period, the terminal may increase the target volume value of the ringtone, and then continuously triggers the location reminder by the ringtone with the increased target volume value for reminding the user where the terminal is. Thus, the user can find the terminal more quickly.

In another some embodiments, before triggering a location reminder by a ringtone with the target volume value for reminding the user where the terminal is, the method further includes the following.

The method obtains a noise value of a current environment in which the terminal is located.

And the method obtains a volume value of the received voice for searching for the terminal, in response to the noise value being less than a preset threshold.

Then, when it is necessary to trigger a location reminder in a preset manner for reminding the user where the terminal is, the following process may be performed. The terminal triggers the location reminder by a ringtone with a volume value of the voice for reminding the user where the terminal is.

For example, when it is determined that the target voiceprint feature meets a preset condition in relation to a preset voiceprint feature and the terminal is located at the preset location, the terminal needs to trigger a location reminder in a preset manner for reminding the user where the terminal is. At this time, the terminal may first obtain a noise value of the current environment. If it is detected that the noise value is less than a preset threshold, then the current environment may be regarded as a quiet environment. At this time, the terminal may acquire a volume value of the received voice for searching for the terminal. Then, the terminal may trigger the location reminder by a ringtone with the volume value for reminding the user where the terminal is.

It can be understood that, in a quiet environment, in order to avoid disturbing other people with excessive voice volume, the user will lower the sound to issue a voice for searching a terminal at a lower volume. In this case, the terminal may output a ringtone according to the received volume value of the voice used for searching the terminal to remind the user where the terminal is. That is, the terminal can output a ringtone with the user's volume. This avoids excessive ringtone to interfere with other users in the current environment.

In some embodiments, when it is necessary to detect whether the terminal is located at a preset location, the terminal can perform positioning detection. For example, the terminal may obtain positioning information, and then detect whether the positioning information is information of the preset location. If the positioning information is information of the preset location, it can be determined that the terminal is located at the preset location. If the positioning information is not information of the preset location, it can be determined that the terminal is not located at the preset location.

Alternatively, the terminal may also determine whether it is located at a preset location through a WiFi access point to which the terminal is currently connected. For example, the preset location is the user's home or company, and generally there are WiFi access points at these locations. The terminal may firstly record information of WiFi access points at these preset locations respectively, and determine a respective one as information of a preset WiFi access point. Then, when it is necessary to determine whether the terminal is located at a preset location, the terminal may also firstly obtain information of a WiFi access point to which the terminal is currently connected. If the information of the WiFi access point to which the terminal is currently connected is detected as information of the preset WiFi access point, it can be determined that the terminal is currently located at a preset location.

In yet another some embodiments, the terminal may comprehensively determine whether the terminal is currently located at a preset location combined with positioning information and information of a WiFi access point.

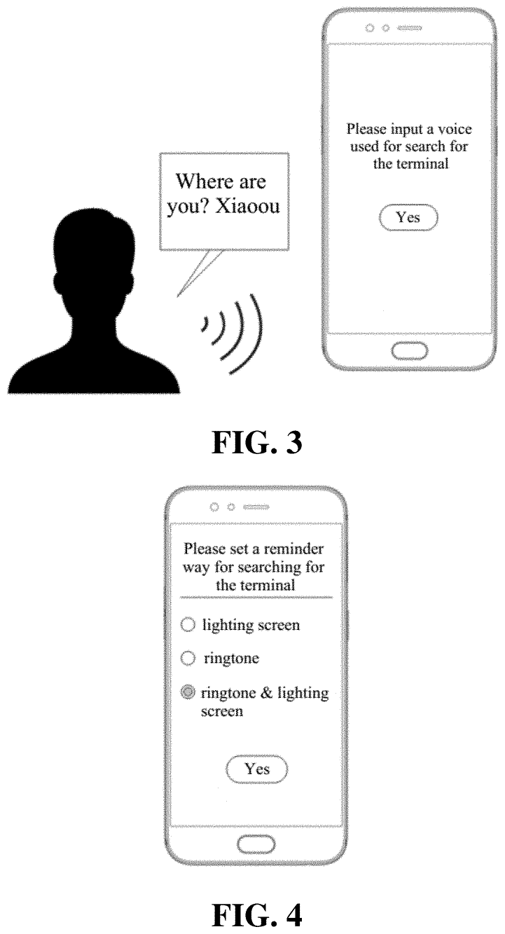

FIG. 3 to FIG. 5 are schematic diagrams of scenarios for a method for location reminder according to some embodiments of the present disclosure.

For example, as shown in FIG. 3, the terminal prompts a user to input a voice used for search for the terminal. For example, a voice input by the user is “Where are you? Xiaoou”. That is, after the user utters the voice of “Where are you? Xiaoou”, when the terminal receives the voice, it will trigger the terminal to implement a function of searching for the terminal if the user is a legal user.

Then, as shown in FIG. 4, the terminal prompts the user to set a reminder way for searching for the terminal, for example, the user selects a reminder way of “ringtone and lighting screen”. That is, when a voice for searching for a terminal issued by a legal user is received, the terminal may use a lighted screen and ringtone to remind the user where the terminal is currently located.

For example, the user currently gets cold and causes inflammation of the throat, and the user issues a hoarse voice. That is, a slight change occurs in the user's voiceprint feature.

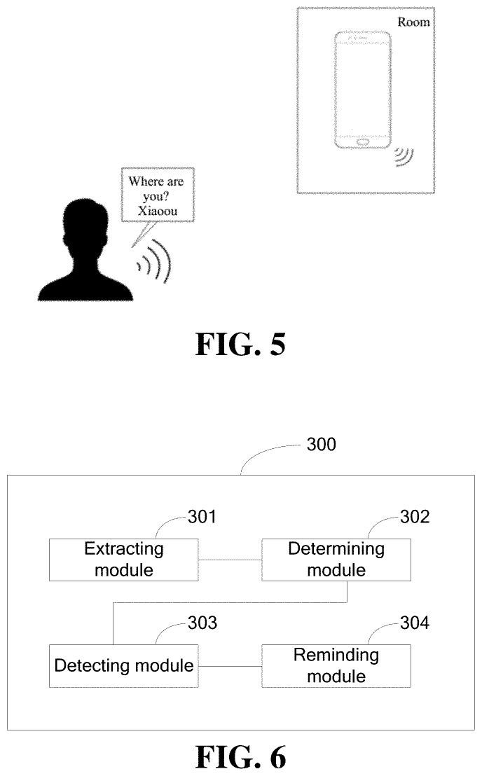

For example, now the user is in the living room at home, the user needs to use the terminal, but the terminal is not at the user's side but in another room, and the user cannot find the terminal for a while. In this case, the user utters the voice of “Where are you? Xiaoou” to find the terminal, as shown in FIG. 5.

The voice is transmitted to the room, and after receiving the voice, the terminal parses the voice to determine that the voice is used for searching for the terminal. At this time, the terminal can extract a target voiceprint feature of the user from the voice.

Then, the terminal may compare the target voiceprint feature with a preset voiceprint feature of the owner, and obtain a target matching degree between the target voiceprint feature and the preset voiceprint feature. Then, the terminal may detect whether the target matching degree reaches a preset matching threshold to determine whether the target voiceprint feature matches with the preset voiceprint feature. For example, in this embodiment, the terminal determines that the target matching degree between the target voiceprint feature and the preset voiceprint feature is less than the preset matching threshold.

At this time, the terminal may further obtain a difference between the target matching degree and a preset matching threshold. For example, the target matching degree is 86%, the preset matching threshold is 90%, and the difference is 4%. Then, the terminal may detect whether the difference is less than or equal to a preset difference. For example, the preset difference is 5%.

As 4% is less than 5%, the terminal can determine that the target voiceprint feature is close to the preset voiceprint feature, and a preset condition is met between the target voiceprint feature and the preset voiceprint feature. In this case, the terminal may acquire current positioning information of the terminal, and determine whether the terminal is at a preset location according to the positioning information. For example, the preset location is the owner's home or company.

For example, in this embodiment, the terminal detects that it is currently in the owner's home. In this case, the terminal may trigger the function of searching for the terminal. That is, the terminal may use a bright screen and a ringtone simultaneously to remind the current user where the terminal is currently located.

For example, in this embodiment, the terminal may first obtain the noise value of the current environment, then determine a target volume value according to the noise value, and then trigger a location reminder by a ringtone with the target volume value and by using a lighted screen for reminding the user where the terminal is.

After hearing the ringtone from the terminal, the user can follow the ringtone to find the terminal in the room.

FIG. 6 is a schematic structural view of an apparatus for location reminder according to some embodiments of the present disclosure. The apparatus 300 includes an extracting module 301, a determining module 302, a detecting module 303, and a reminding module 304.

The extracting module 301 is configured for extracting a target voiceprint feature from a voice configured for searching for a terminal.

The determining module 302 is configured for determining whether the target voiceprint feature meets a preset condition in relation to a preset voiceprint feature, in response to the target voiceprint feature unmatching with the preset voiceprint feature;

The detecting module 303 is configured for detecting whether the terminal is located at a preset location in response to the target voiceprint feature meeting the preset condition in relation to the preset voiceprint feature.

The reminding module 304 is configured for triggering a location reminder in a preset manner for reminding a user where the terminal is, in response to the terminal being located at the preset location.

In some embodiments, the determining module 302 is configured for:

obtaining a target matching degree between the target voiceprint feature and the preset voiceprint feature;

obtaining a difference between the target matching degree and a preset matching threshold;

determining the target voiceprint feature meets the preset condition in relation to the preset voiceprint feature, in response to the difference being less than or equal to a preset difference; and

determining the target voiceprint feature does not meet the preset condition in relation to the preset voiceprint feature, in response to the difference being greater than the preset difference.

In some embodiments, the detecting module 303 is configured for:

obtaining information of a WiFi access point to which the terminal is currently connected; and

determining whether the information of the WiFi access point is information of a preset WiFi access point, and determining that the terminal is located at the preset location, in response the information of the WiFi access point being the information of the preset WiFi access point, wherein the information of the preset WiFi access point being information of any of at least one WiFi access point at the preset location.

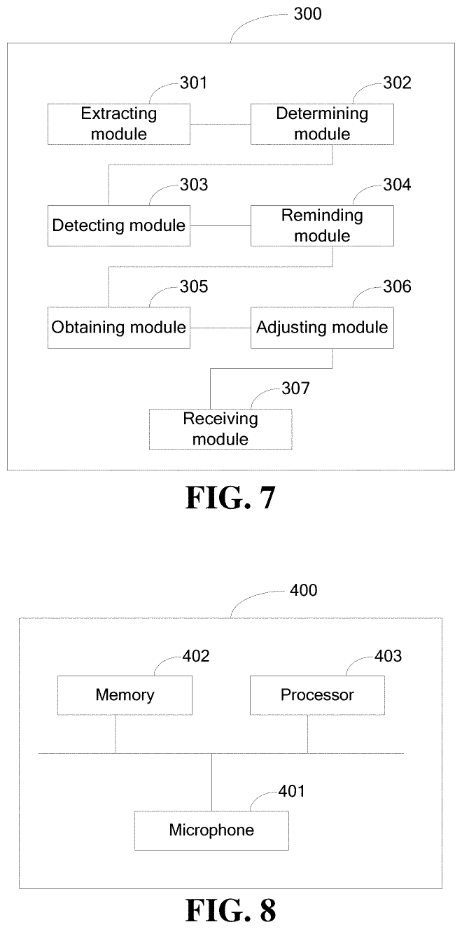

FIG. 7 is another schematic structural view of an apparatus for location reminder according to some embodiments of the present disclosure. In some embodiments, the apparatus further includes an obtaining module 305, an adjusting module 306, and a receiving module 307.

The obtaining module 305 is configured for obtaining a noise value of a current environment in which the terminal is located; and determining a target volume value according to the noise value.

Then, the reminding module 304 is configured for triggering the location reminder by a ringtone with the target volume value for reminding the user where the terminal is.

In some embodiments, the larger the noise value of the current environment is, the larger the target volume value is.

The adjusting module 306 is configured for increasing the target volume value of the ringtone, in response to the terminal not being found by the user after a preset duration; and continuously triggering the location reminder by the ringtone with the increased target volume value for reminding the user where the terminal is.

The receiving module 307 is configured for obtaining a noise value of a current environment in which the terminal is located; and obtaining a volume value of the voice, in response to the noise value is less than a preset threshold

Then, the reminding module 304 is configured for continuously triggering the location reminder by a ringtone with the volume value for reminding the user where the terminal is.

Embodiments of the present disclosure provides a storage medium storing a computer program, when executed on a computer, causing the computer to perform actions/operations in the above method.

Embodiments of the present disclosure further provides an electronic device comprising a memory and a processor, wherein the processor calls a computer program stored in the memory to perform actions/operations in the above method according to embodiments of the present disclosure.

For example, the electronic device may be a mobile terminal such as a tablet computer or a smart phone. FIG. 8 is a structural view of an electronic device according to some embodiments of the present disclosure.

The electronic device 400 may include a microphone 401, a non-transitory memory 402, a processor 403 and the like. It may be understood by those skilled in the art that a structure of the electronic device shown in FIG. 8 does not constitute a limitation to the electronic device, and may include more or fewer components than what is shown, or combinations of some components, or different component arrangements.

The microphone 401 is configured for picking up voices spoked by the user.

The non-transitory memory 402 can be used to store application programs and data. The application programs stored in the non-transitory memory 402 contains executable codes. The application programs may be formed as various functional modules. The processor 403 implements various function applications and data processing by executing the application programs stored in the non-transitory memory 402.

The processor 403 is a control center of the electronic device, and is configured to be connected all parts of the electronic device via various interfaces and lines. Various functions and data processing of the electronic device may be implemented by running or executing the application programs stored in the non-transitory memory 402 and calling data stored in the non-transitory memory 402. Thus, the electronic device may be monitored wholly.

In this embodiment, the processor 403 in the electronic device loads the executable codes corresponding to one or more process of the application programs into the non-transitory memory 402, and the application programs stored in the non-transitory memory 402 are executed by the processor 403 such that the following actions/operations may be implemented.

Extracting a target voiceprint feature from a voice configured for searching for a terminal.

Determining whether the target voiceprint feature meets a preset condition in relation to a preset voiceprint feature, in response to the target voiceprint feature unmatching with the preset voiceprint feature.

Detecting whether the terminal is located at a preset location in response to the target voiceprint feature meeting the preset condition in relation to the preset voiceprint feature.

And triggering a location reminder in a preset manner for reminding a user where the terminal is, in response to the terminal being located at the preset location.

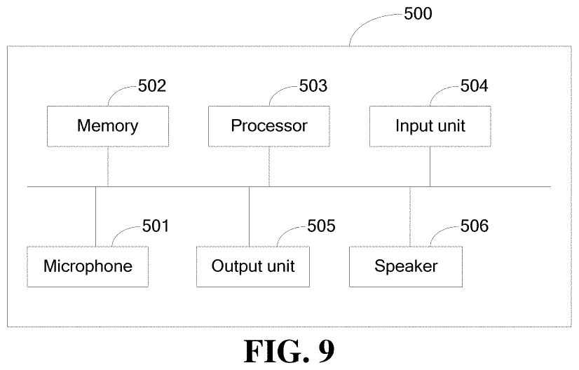

As shown in FIG. 9, a mobile terminal 500 includes a microphone 501, a non-transitory memory 502, a processor 503, an input unit 504, an output unit 505, a speaker 506, and the like.

The microphone 501 is configured for picking up voices spoked by the user.

The non-transitory memory 502 can be used to store application programs and data. The application programs stored in the non-transitory memory 502 contains executable codes. The application programs may be formed as various functional modules. The processor 503 implements various function applications and data processing by executing the application programs stored in the non-transitory memory 502.

The processor 503 is a control center of the electronic device, and is configured to be connected all parts of the electronic device via various interfaces and lines. Various functions and data processing of the electronic device may be implemented by running or executing the application programs stored in the non-transitory memory 502 and calling data stored in the non-transitory memory 502. Thus, the electronic device may be monitored wholly.

The input unit 504 may be used for receiving inputted numbers, character information, or user characteristic information (such as fingerprints), and generating input signals of a keyboard, a mouse, a joystick, an optical or trackball related to user settings and function control.

The output unit 505 may be used for displaying information input by the user or information provided to the user and various graphical user interfaces of the mobile terminal. These graphical user interfaces may include graphics, texts, icons, videos, and any combination thereof. The output unit may include a display panel.

In this embodiment, the processor 503 in the electronic device loads the executable codes corresponding to one or more process of the application programs into the non-transitory memory 502, and the application programs stored in the non-transitory memory 502 are executed by the processor 503 such that the following actions/operations may be implemented.

Extracting a target voiceprint feature from a voice configured for searching for a terminal.

Determining whether the target voiceprint feature meets a preset condition in relation to a preset voiceprint feature, in response to the target voiceprint feature unmatching with the preset voiceprint feature.

Detecting whether the terminal is located at a preset location in response to the target voiceprint feature meeting the preset condition in relation to the preset voiceprint feature.

And triggering a location reminder in a preset manner for reminding a user where the terminal is, in response to the terminal being located at the preset location.

In some embodiments, before the triggering a location reminder in a preset manner for reminding a user where the terminal is, the processor 503 further performs obtaining a noise value of a current environment in which the terminal is located; and determining a target volume value according to the noise value.

Then, as performing the triggering a location reminder in a preset manner for reminding a user where the terminal is, the processor 503 performs triggering the location reminder by a ringtone with the target volume value for reminding the user where the terminal is.

In some embodiments, after the triggering the location reminder by a ringtone with the target volume value, the processor 503 further performs increasing the target volume value of the ringtone, in response to the terminal not being found by the user after a preset duration; and continuously triggering the location reminder by the ringtone with the increased target volume value for reminding the user where the terminal is.

In some embodiments, before the triggering a location reminder in a preset manner for reminding a user where the terminal is, the processor 503 further performs obtaining a noise value of a current environment in which the terminal is located; and obtaining a volume value of the voice, in response to the noise value is less than a preset threshold.

Then, as performing the triggering a location reminder in a preset manner for reminding a user where the terminal is, the processor 503 performs continuously triggering the location reminder by a ringtone with the volume value for reminding the user where the terminal is.

In some embodiments, as performing the determining whether the target voiceprint feature meets a preset condition in relation to a preset voiceprint feature, the processor 503 further performs obtaining a target matching degree between the target voiceprint feature and the preset voiceprint feature; obtaining a difference between the target matching degree and a preset matching threshold; determining the target voiceprint feature meets the preset condition in relation to the preset voiceprint feature, in response to the difference being less than or equal to a preset difference; and determining the target voiceprint feature does not meet the preset condition in relation to the preset voiceprint feature, in response to the difference being greater than the preset difference.

In some embodiments, the larger the noise value of the current environment is, the larger the target volume value is.

In some embodiments, as performing the determining whether the terminal is located at a preset location, the processor 503 further performs obtaining information of a WiFi access point to which the terminal is currently connected; determining whether the information of the WiFi access point is information of a preset WiFi access point, wherein the information of the preset WiFi access point being information of any of at least one WiFi access point at the preset location; and determining that the terminal is located at the preset location, in response the information of the WiFi access point being the information of the preset WiFi access point.

In the foregoing embodiments, the descriptions of the various embodiments are different, and the detailed descriptions for some embodiments may be referred from the detailed description of the above methods for image-processing, which are not described herein.

The apparatus for location reminder according to embodiments of the present disclosure belongs to the same concept as the method for location reminder in the above embodiments. Any method, whose implementation processes are described in the methods for location reminder in the above embodiments, may be run on the apparatus for image-processing, which will not described herein again.

It should be noted that, for the method of location reminder in the embodiments of the present disclosure, those skilled in the art can understand that all or part of a process of implementing the method for location reminder in the embodiments of the present disclosure is implemented through controlling related hardware by computer programs. The computer programs can be stored in a computer readable storage medium, such as a memory, and executed by at least one processor. The computer programs can include an implementation of the method for location reminder as described during the execution. The storage medium may be a magnetic disk, an optical disk, a read only memory (ROM), a random access memory (RAM), or the like.

For the apparatus for location reminder of embodiments of the present disclosure, each functional module may be integrated into one processing chip, or each module may exist physically separately, or two or more modules may be integrated into one module. The above integrated modules can be implemented in the form of hardware or in the form of software functional modules. The integrated module, if implemented in the form of a software functional module and sold or used as a standalone product, may also be stored in a computer readable storage medium, such as a read only memory, a magnetic disk or an optical disk, etc.

The method for location reminder and the electronic device in embodiments of the present disclosure are described in detail. The principles and implementations of the present disclosure are described with examples. The description of the above embodiments is only used to help understand a method and a core idea of the present disclosure. Meanwhile, for those skilled in the art, there will be changes in specific embodiments and disclosure scopes according to the idea of the present disclosure. The descriptions should not be construed to limit the present disclosure.

What is claimed is:

1. A method for location reminder, comprising:
extracting a target voiceprint feature from a voice configured for searching for a terminal;
determining whether the target voiceprint feature meets a preset condition in relation to a preset voiceprint feature, in response to the target voiceprint feature unmatching with the preset voiceprint feature;
detecting whether the terminal is located at a preset location in response to the target voiceprint feature meeting the preset condition in relation to the preset voiceprint feature; and
triggering a location reminder in a preset manner for reminding a user where the terminal is, in response to the terminal being located at the preset location.

2. The method as claimed in claim 1, further comprising:
before the triggering the location reminder in the preset manner for reminding the user where the terminal is:
obtaining a noise value of a current environment in which the terminal is located; and
determining a target volume value according to the noise value;
wherein the triggering the location reminder in a preset manner for reminding the user where the terminal is further comprises:
triggering the location reminder by a ringtone with the target volume value for reminding the user where the terminal is.

3. The method as claimed in claim 2, further comprising:
after the triggering the location reminder by the ringtone with the target volume value:
increasing the target volume value of the ringtone, in response to the terminal not being found by the user after a preset duration; and
continuously triggering the location reminder by the ringtone with the increased target volume value for reminding the user where the terminal is.

4. The method as claimed in claim 1, further comprising:
before the triggering the location reminder in the preset manner for reminding the user where the terminal is:
obtaining a noise value of a current environment in which the terminal is located; and
obtaining a volume value of the voice, in response to the noise value is less than a preset threshold;
wherein the triggering the location reminder in the preset manner for reminding the user where the terminal is further comprises:
continuously triggering the location reminder by a ringtone with the volume value for reminding the user where the terminal is.

5. The method as claimed in claim 1, wherein the determining whether the target voiceprint feature meets the preset condition in relation to the preset voiceprint feature comprises:
obtaining a target matching degree between the target voiceprint feature and the preset voiceprint feature;
obtaining a difference between the target matching degree and a preset matching threshold;
determining the target voiceprint feature meets the preset condition in relation to the preset voiceprint feature, in response to the difference being less than or equal to a preset difference; and
determining the target voiceprint feature does not meet the preset condition in relation to the preset voiceprint feature, in response to the difference being greater than the preset difference.

6. The method as claimed in claim 2, wherein the larger the noise value is, the larger the target volume value is.

7. The method as claimed in claim 1, wherein the determining whether the terminal is located at the preset location comprises:
obtaining information of a WiFi access point to which the terminal is currently connected;
determining whether the information of the WiFi access point is information of a preset WiFi access point, wherein the information of the preset WiFi access point being information of any of at least one WiFi access point at the preset location; and
determining that the terminal is located at the preset location, in response the information of the WiFi access point being the information of the preset WiFi access point.

8. An electronic device, comprising a memory and a processor, wherein the processor is configured for executing a computer program stored in the memory to perform:
extracting a target voiceprint feature from a voice configured for searching for a terminal;
determining whether the target voiceprint feature meets a preset condition in relation to a preset voiceprint feature, in response to the target voiceprint feature unmatching with the preset voiceprint feature;
detecting whether the terminal is located at a preset location in response to the target voiceprint feature meeting the preset condition in relation to the preset voiceprint feature; and
triggering a location reminder in a preset manner for reminding a user where the terminal is, in response to the terminal being located at the preset location.

9. The electronic device as claimed in claim 8, wherein the processor is configured to perform:
obtaining a noise value of a current environment in which the terminal is located;
determining a target volume value according to the noise value; and
triggering the location reminder by a ringtone with the target volume value for reminding the user where the terminal is.

10. The electronic device as claimed in claim 9, wherein the processor is configured to perform:
increasing the target volume value of the ringtone, in response to the terminal not being found by the user after a preset duration; and
continuously triggering the location reminder by the ringtone with the increased target volume value for reminding the user where the terminal is.

11. The electronic device as claimed in claim 8, wherein the processor is configured to perform:
obtaining a noise value of a current environment in which the terminal is located;
obtaining a volume value of the voice in response to the noise value is less than a preset threshold; and
triggering the location reminder by a ringtone with the volume value for reminding the user where the terminal is.

12. The electronic device as claimed in claim 8, wherein the processor is configured to perform:
obtaining a target matching degree between the target voiceprint feature and the preset voiceprint feature;
obtaining a difference between the target matching degree and a preset matching threshold;
determining the target voiceprint feature meets the preset condition in relation to the preset voiceprint feature, in response to the difference being less than or equal to a preset difference; and
determining the target voiceprint feature does not meet the preset condition in relation to the preset voiceprint feature, in response to the difference being greater than the preset difference.

13. The electronic device as claimed in claim 9, wherein the larger the noise value is, the larger the target volume value is.

14. The electronic device as claimed in claim 8, wherein the processor is configured to perform:
obtaining information of a WiFi access point to which the electronic device is currently connected; and
determining whether the information of the WiFi access point is information of a preset WiFi access point, wherein the information of the preset WiFi access point being information of any of at least one WiFi access point at the preset location; and
determining that the electronic device is located at the preset location in response the information of the WiFi access point being the preset information of the WiFi access point.

15. A non-transitory storage medium storing a computer program, when executed on a computer, causing the computer to perform:
determining whether a target voiceprint feature meets a preset condition in relation to a preset voiceprint feature, in response to the target voiceprint feature unmatching with the preset voiceprint feature, the target voiceprint feature being extracted from a voice configured for searching for a terminal;
detecting whether the terminal is located at a preset location in response to the target voiceprint feature meeting the preset condition in relation to the preset voiceprint feature; and
triggering a location reminder in a preset manner for reminding a user where the terminal is, in response to the terminal being located at the preset location.

16. The non-transitory storage medium as claimed in claim 15, wherein the computer program causes the computer to further perform:
obtaining a noise value of a current environment in which the terminal is located;
determining a target volume value according to the noise value; and
triggering the location reminder by a ringtone with the target volume value for reminding the user where the terminal is.

17. The non-transitory storage medium as claimed in claim 16, wherein the computer program causes the computer to further perform:
increasing the target volume value of the ringtone, in response to the terminal not being found by the user after a preset duration; and
continuously triggering the location reminder by the ringtone with the increased target volume value for reminding the user where the terminal is.

18. The non-transitory storage medium as claimed in claim 16, wherein the larger the noise value is, the larger the target volume value is.

19. The non-transitory storage medium as claimed in claim 15, wherein the computer program causes the computer to further perform:
obtaining a target matching degree between the target voiceprint feature and the preset voiceprint feature;
obtaining a difference between the target matching degree and a preset matching threshold;
determining the target voiceprint feature meets the preset condition in relation to the preset voiceprint feature, in response to the difference being less than or equal to a preset difference; and
determining the target voiceprint feature does not meet the preset condition in relation to the preset voiceprint feature, in response to the difference being greater than the preset difference.

20. The non-transitory storage medium as claimed in claim 15, wherein the computer program causes the computer to further perform:
obtaining information of a WiFi access point to which the terminal is currently connected; and
determining whether the information of the WiFi access point is information of a preset WiFi access point, wherein the information of the preset WiFi access point being information of any of at least one WiFi access point at the preset location; and
determining that the terminal is located at the preset location, in response the information of the WiFi access point being the information of the preset WiFi access point.
